(19) United States
(12) Patent Application Publication
(10) Pub. No.: US 2012/0171414 A1
(43) Pub. Date: Jul. 5, 2012

(54) Apparatus and Method for a User Input Element in an Electronic Device

(75) Inventors: Ralf Wieser, Beimerstetten (DE); Somakanthan Somalingam, Ulm (DE)

(73) Assignee: NOKIA CORPORATION, Espoo (FI)

(21) Appl. No.: 12/984,292

(22) Filed: Jan. 4, 2011

(51) Int. Cl. B32B 3/10; B23P 11/00

(52) U.S. Cl. 428/134; 29/428

(57) ABSTRACT

In accordance with an example embodiment of the present invention, an apparatus is provided, comprising: a user input element body; a photochrome layer, the photochrome layer disposed on a surface of the user input element body; and an aperture through the photochrome layer, the aperture having a character shape.

### TECHNICAL FIELD

The present application relates generally to an apparatus and method for a user input element in an electronic device.

### BACKGROUND

Electronic devices are generally provided with various user input elements that enable users to interact with devices. User input elements such as keys, knobs, and buttons can have a considerable variety of shapes, markings, and surface finish options.

Electronic devices can be operated on a broad range of usage situations and lighting conditions. It is desirable that markings of user input elements are easily distinguishable in various conditions so that the user can identify the purpose or function assigned to a user input element.

### SUMMARY

Various aspects of examples of the invention are set out in the claims.

According to a first aspect of the present invention, an apparatus is provided, comprising: a user input element body; a photochrome layer, the photochrome layer disposed on a surface of the user input element body; and an aperture through the photochrome layer, the aperture having a character shape.

According to a second aspect of the present invention, a method is provided, comprising: providing a user input element body; providing a photochrome layer, the photochrome layer disposed on a surface of the user input element body; and forming an aperture through the photochrome layer, the aperture having a character shape.

### BRIEF DESCRIPTION OF THE DRAWINGS

For a more complete understanding of example embodiments of the present invention, reference is now made to the following descriptions taken in connection with the accompanying drawings in which:

FIG. 1a is a diagram illustrating a cross-sectional view of a user input element comprising a photochrome layer on a top surface, according to an example embodiment of the invention;

FIG. 1b is a diagram illustrating a cross-sectional view of a user input element comprising a photochrome layer on a back surface, according to an example embodiment of the invention;

FIG. 2a is a diagram illustrating a top view of a user input element comprising a photochrome layer, with illumination having a first illumination level, according to an example embodiment of the invention;

FIG. 2b is a diagram illustrating a top view of a user input element comprising a photochrome layer, with illumination having a second illumination level, according to an example embodiment of the invention;

FIG. 3a is a diagram illustrating a cross-sectional view of a user input element comprising a photochrome layer and a color layer on a top surface, according to an example embodiment of the invention;

FIG. 3b is a diagram illustrating a cross-sectional view of a user input element comprising a photochrome layer and a color layer on a back surface, according to an example embodiment of the invention;

FIG. 4a is a diagram illustrating a top view of a user input element comprising a photochrome layer and a color layer, with illumination having a first illumination level, according to an example embodiment of the invention;

FIG. 4b is a diagram illustrating a top view of a user input element comprising a photochrome layer and a color layer, with illumination having a second illumination level, according to an example embodiment of the invention;

FIG. 5 is a diagram illustrating a mobile electronic device comprising a user input element, according to an example embodiment of the invention;

FIG. 6 is a flow diagram illustrating a method of manufacturing a user input element comprising a photochrome layer, according to an example embodiment of the invention; and

FIG. 7 is a flow diagram illustrating a method of manufacturing a user input element comprising a photochrome layer and a color layer, according to an example embodiment of the invention.

### DETAILED DESCRIPTION OF THE DRAWINGS

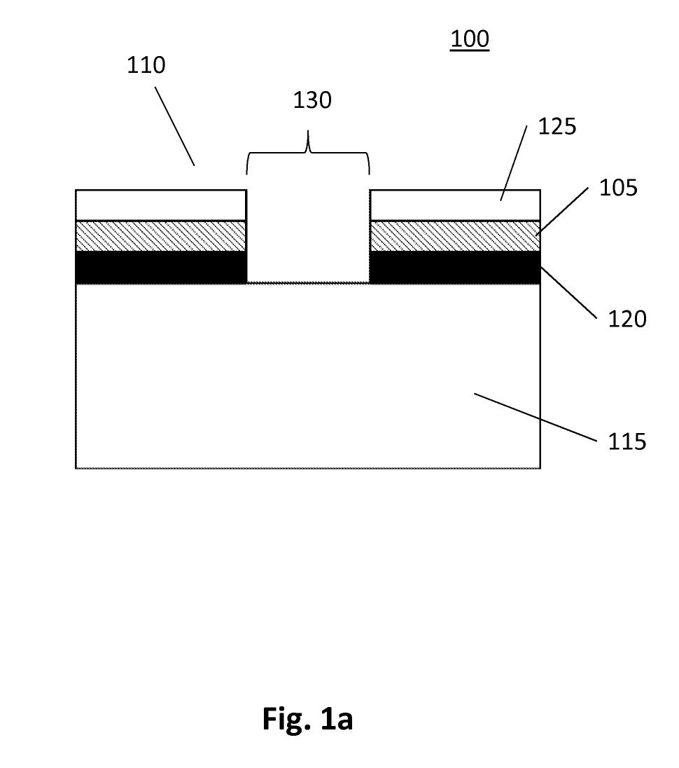

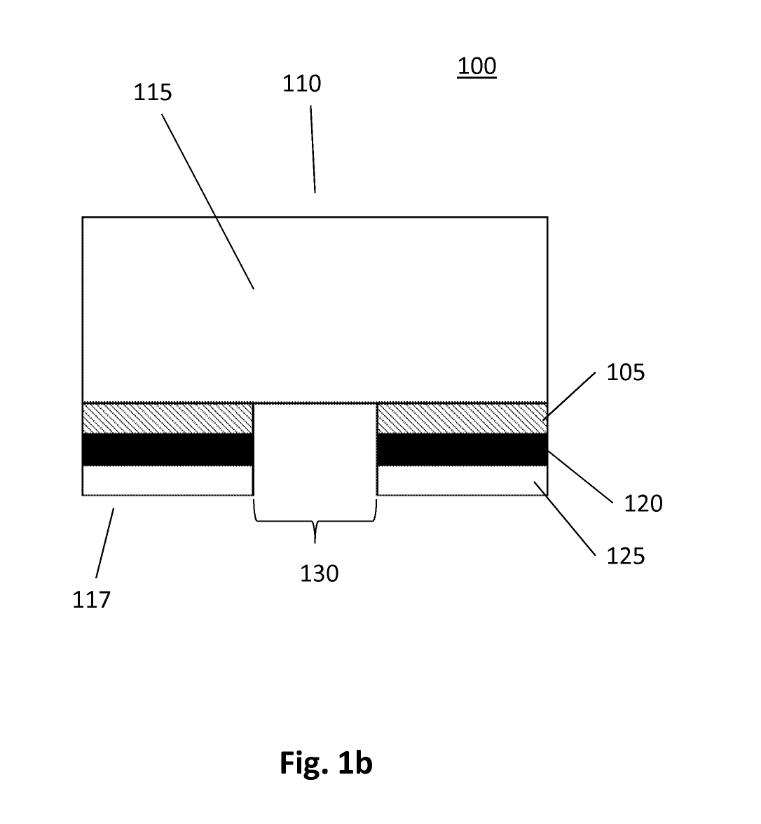

An example embodiment of the present invention and its potential advantages are understood by referring to FIGS. 1 through 7 of the drawings.

FIG. 1a is a diagram illustrating a cross-sectional view of a user input element 100 comprising a photochrome layer 105 on a top surface 110, according to an example embodiment of the invention. The top surface 110 is a surface which is configured to be exposed and accessible to a user and to receive a force exerted by a finger or other object.

The photochrome layer 105 is a layer comprising a photochromic material having photochromic characteristics. The photochromic material has an absorption spectrum which changes reversibly as a function of intensity of the illumination that the photochromic material is exposed to. The photochromic material has different color shades at different levels of illumination. The photochromic material has a first shade at a first level of illumination, and a second shade at a second level of illumination which is higher than the first level. In an embodiment, the first shade is a light shade, and the second shade is a dark shade. In an embodiment, the light shade is white. In an embodiment, the dark shade is black, or a dark shade of a color such as red, blue, or green. However, the first and second shades can be any colors without departing from the spirit of the invention. In an embodiment, the photochromic material is selected from spiropyran and spirooxazine. However, any suitable photochromic material may be used without departing from the spirit of the invention.

The user input element 100 comprises a user input element body 115. In an embodiment, the user input element body 115 comprises a translucent material that permits at least partial transmission of light through the user input element body 115. The translucent material may be translucent for visible light, and it may be translucent for other parts of the electromagnetic radiation spectrum, such as infrared or ultraviolet light. The translucent material is polycarbonate (PC), poly(methyl methacrylate) (PMMA), or any other suitable material. In an embodiment, the user input element body 115 is injection molded as one piece, but other structures and manufacturing methods are possible without departing from the spirit of the invention.

In an embodiment, the user input element 100 comprises a backing layer 120 overlaying at least a portion of the top surface 110. The backing layer 120 may be facing and in contact with the user input element body 115. In an embodiment, the backing layer 120 comprises a dark shade, such as black. In an embodiment, the backing layer 120 is substantially opaque, allowing no transmission or only minimal transmission of light. The backing layer 120 may extend to one or more other surfaces of the user input element 100.

In an embodiment, the backing layer 120 is disposed adjacent to the photochrome layer 105. In an embodiment, the photochrome layer 105 may be overlaying at least a portion of the backing layer 120 in such a way that the backing layer 120 is located between the photochrome layer 105 and the user input element body 115. The photochrome layer 105 may extend to one or more other surfaces of the user input element 100.

In an embodiment, the user input element 100 comprises a protective layer 125. The protective layer 125 is overlaying at least a portion of the photochrome layer 105. The protective layer may be facing and in contact with the photochrome layer 105. In an embodiment, the protective layer 125 comprises a durable plastic material, and it is configured to protect the photochrome layer 105 against impacts and wear. In an embodiment, the protective layer 125 is translucent in such a way that it permits at least partial transmission of light. The protective layer 125 may be translucent for visible light, and it may be translucent for other parts of the electromagnetic radiation spectrum, such as infrared or ultraviolet light. The protective layer 125 may extend to one or more other surfaces of the user input element 100.

In an embodiment, the user input element 100 comprises an aperture 130 extending through the photochrome layer 105, and the backing layer 120, and exposing a portion of the user input element body 115. The aperture may extend through the protective layer 125.

FIG. 1b is a diagram illustrating a cross-sectional view of a user input element 100 comprising a photochrome layer 105 on a back surface 117, according to an example embodiment of the invention. The back surface 117 is a surface generally opposite and facing away from a top surface 110. The top surface 110 is a surface which is configured to be exposed and accessible to a user and to receive a force exerted by a finger or other object.

The photochrome layer 105 is a layer comprising a photochromic material having photochromic characteristics. The photochromic material has an absorption spectrum which changes reversibly as a function of intensity of the illumination that the photochromic material is exposed to. The photochromic material has different color shades at different levels of illumination. The photochromic material has a first shade at a first level of illumination, and a second shade at a second level of illumination which is higher than the first level. In an embodiment, the first shade is a light shade, and the second shade is a dark shade. In an embodiment, the light shade is white. In an embodiment, the dark shade is black, or a dark shade of a color such as red, blue, or green. However, the first and second shades can be any colors without departing from the spirit of the invention. In an embodiment, the photochromic material is selected from spiropyran and spirooxazine. However, any suitable photochromic material may be used without departing from the spirit of the invention.

The user input element 100 comprises a user input element body 115. In an embodiment, the user input element body 115 comprises a translucent material that permits at least partial transmission of light through the user input element body 115. The translucent material may be translucent for visible light, and it may be translucent for other parts of the electromagnetic radiation spectrum, such as infrared or ultraviolet light. The translucent material is polycarbonate (PC), poly(methyl methacrylate) (PMMA), or any other suitable material. In an embodiment, the user input element body 115 is injection molded as one piece, but other structures and manufacturing methods are possible without departing from the spirit of the invention.

In an embodiment, the photochrome layer 105 is overlaying at least a portion of the back surface 117. The photochrome layer 105 may be facing and in contact with the user input element body 115. The photochrome layer 105 may extend to one or more other surfaces of the user input element 100.

In an embodiment, the user input element 100 comprises a backing layer 120 overlaying at least a portion of the photochrome layer 105. The backing layer may be facing and in contact with the photochrome layer 105. In an embodiment, the backing layer 120 comprises a dark shade, such as black. In an embodiment, the backing layer 120 is substantially opaque, allowing no transmission or only minimal transmission of light. The backing layer 120 may extend to one or more other surfaces of the user input element 100.

In an embodiment, the user input element 100 comprises a protective layer 125. The protective layer 125 is overlaying at least a portion of the backing layer 105. The protective layer 125 may be facing and in contact with the backing layer 120. In an embodiment, the protective layer 125 comprises a durable plastic material, and it is configured to protect the backing layer 105 against impacts and wear. In an embodiment, the protective layer 125 is translucent in such a way that it permits at least partial transmission of light. The protective layer 125 may be translucent for visible light, and it may be translucent for other parts of the electromagnetic radiation spectrum, such as infrared or ultraviolet light. The protective layer 125 may extend to one or more other surfaces of the user input element 100.

In an embodiment, the user input element 100 comprises an aperture 130 extending through the backing layer 120, and the photochrome layer 105, exposing a portion of the user input element body 115. The aperture may extend through the protective layer 125.

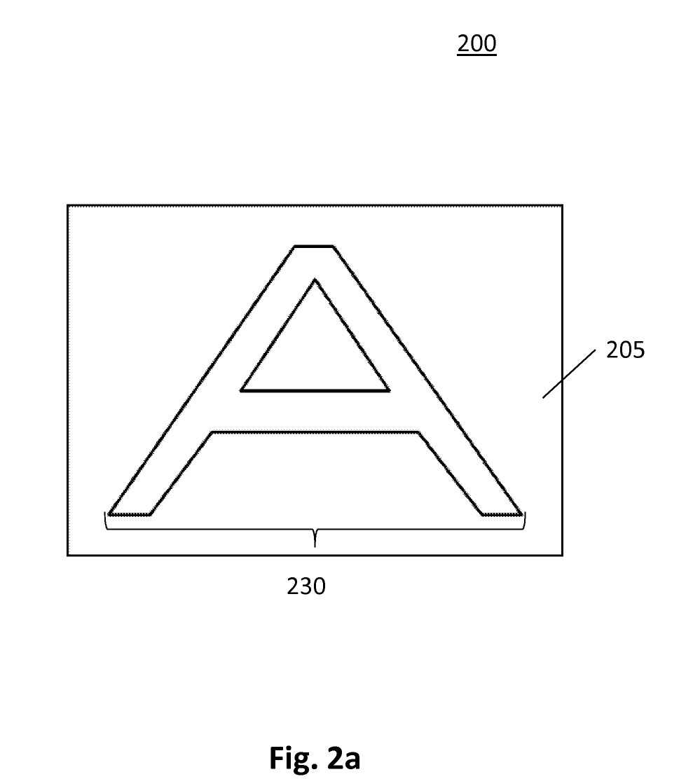

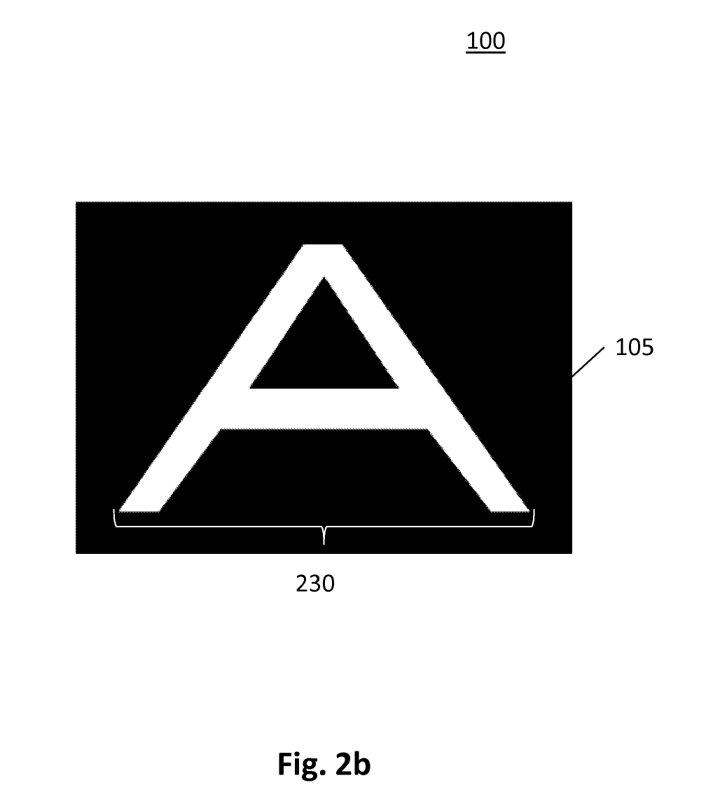

FIG. 2a is a diagram illustrating a top view of a user input element 200 comprising a photochrome layer 205, with illumination having a first illumination level, according to an example embodiment of the invention. The first illumination level may be a low illumination level. The user input element 200 may be the user input element 100 of FIG. 1a or 1b, and the photochrome layer 205 may be the photochrome layer 105 of FIG. 1a or 1b. FIG. 2a illustrates the user input element 200 from the viewpoint of a user, from a direction approximately perpendicular to the top surface 110 of FIG. 1a or 1b. In the user input element 100 of FIG. 1a, the photochrome layer 105 may be visible through the protective layer 125 of FIG. 1a. In the user input element 100 of FIG. 1b, the photochrome layer 105 may be visible through the user input element body 115 of FIG. 1b. In an embodiment, the user input element comprises a photochrome layer 205 both on a top surface such as in FIG. 1a and on a back surface such as in FIG. 1b.

In an embodiment, the user input element 200 comprises a character shaped aperture 230, which may be the aperture 130 of FIG. 1a or 1b. The character shaped aperture 230 shown in FIG. 2a is a capital letter “A” of the Latin alphabet. However, the character shaped aperture 230 may be any letter of any alphabet writing system, any numeral character of any numeral system, a punctuation mark, a special character, or any other symbol or shape. In an embodiment, the character shaped aperture 230 comprises a plurality of symbols or shapes, such as a group of letters forming a word.

In an embodiment, the user input element 200 is configured for installation in a device comprising a backlight arrangement. In an embodiment, the backlight arrangement is configured to emit white light. However, any color or a combination of colors can be used without departing from the spirit of the invention. In an embodiment, the user input element 200 is configured to be installed in the device in such a way that at least part of the light emitted by the backlight arrangement is directed through the user input element body 115 of FIG. 1a or 1b. In an embodiment, the photochrome layer 205 is configured to form a luminance contrast with the user input element body 115 of FIG. 1a or 1b at the first illumination level at least when the backlight arrangement is emitting light. In an embodiment, the character shaped aperture 230 appears from the user's point of view as a region of substantially higher luminance compared with the surrounding photochrome layer 205 so that the character shaped aperture 230 is easily distinguishable when the backlight arrangement is emitting light.

FIG. 2b is a diagram illustrating a top view of a user input element 200 comprising a photochrome layer 205, with illumination having a second illumination level, according to an example embodiment of the invention. The second illumination level may be a high illumination level. The user input element 200 may be the user input element 100 of FIG. 1a or 1b, and the photochrome layer 205 may be the photochrome layer 105 of FIG. 1a or 1b. FIG. 2b illustrates the user input element 200 from the viewpoint of a user, from a direction approximately perpendicular to the top surface 110 of FIG. 1a or 1b. In the user input element 100 of FIG. 1a, the photochrome layer 105 may be visible through the protective layer 125 of FIG. 1a. In the user input element 100 of FIG. 1b, the photochrome layer 105 may be visible through the user input element body 115 of FIG. 1b. In an embodiment, the user input element comprises a photochrome layer 205 both on a top surface such as in FIG. 1a and on a back surface such as in FIG. 1b.

In an embodiment, the user input element 200 comprises a character shaped aperture 230, which may be the aperture 130 of FIG. 1a or 1b. The character shaped aperture 230 shown in FIG. 2a is a capital letter “A” of the Latin alphabet. However, the character shaped aperture 230 may be any letter of any alphabet writing system, any numeral character of any numeral system, a punctuation mark, a special character, or any other symbol or shape. In an embodiment, the character shaped aperture 230 comprises a plurality of symbols or shapes, such as a group of letters forming a word.

In an embodiment, the photochrome layer 205 is configured to form a color contrast with the user input element body 115 of FIG. 1a or 1b at the second illumination level. In an embodiment, the photochrome layer is configured to have, at the second illumination level, a color sufficiently different from the user input element body so that the character shaped aperture 230 is easily distinguishable. In an embodiment, the character shaped aperture 230 appears from the user's point of view as a region of substantially different color compared with the surrounding photochrome layer 205.

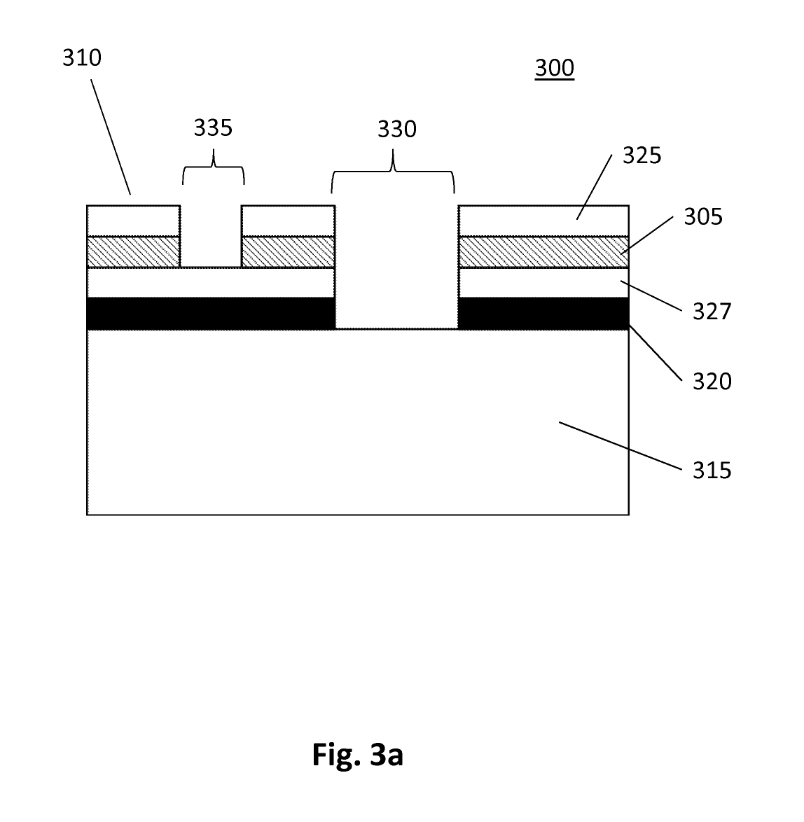

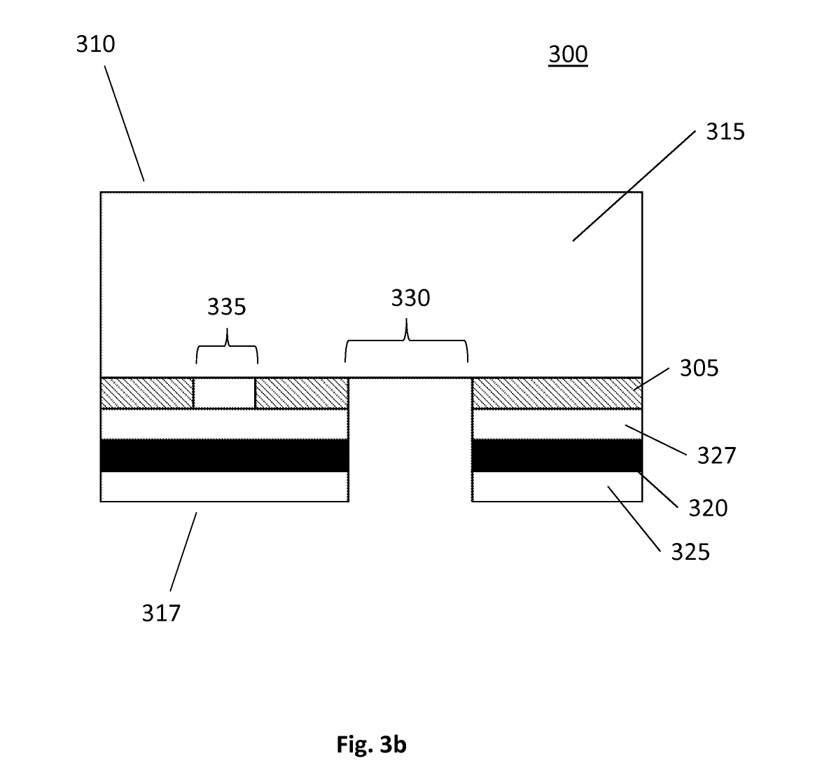

FIG. 3a is a diagram illustrating a cross-sectional view of a user input element 300 comprising a photochrome layer 305 and a color layer 327 on a top surface 310, according to an example embodiment of the invention. The top surface 310 is a surface which is configured to be exposed and accessible to a user and to receive a force exerted by a finger or other object. The photochrome layer 305 may be similar to the photochrome layer 105 of FIG. 1a. The user input element 300 comprises a user input element body 315 which may be similar to the user input element body 115 of FIG. 1a, and a backing layer 320 which may be similar to the backing layer 120 of FIG. 1a.

In an embodiment, the color layer 327 is a layer comprising a light color such as white. However, any suitable color is possible without departing from the spirit of the invention. In an embodiment, the color of the color layer 327 is selected in such a way that at a first illumination level the photochrome layer 305 has a shade resembling the color of the color layer 327, and at a second illumination level the photochrome layer 305 has a shade differing from the color of the color layer 327. In an embodiment, the photochrome layer 305 and the color layer 327 are substantially not distinguishable from each other at the first illumination level. In an embodiment, the photochrome layer 305 and the color layer 327 are easily distinguishable from each other at the second illumination level.

In an embodiment, the color layer 327 is overlaying the backing layer 320. The color layer 327 may be facing and in contact with the backing layer 320 and the photochrome layer 305 in such a way that the color layer 327 is located between the backing layer 320 and the photochrome layer 305. The color layer 327 may extend to one or more other surfaces of the user input element 100.

In an embodiment, the user input element 300 comprises a protective layer 325. The protective layer 325 is overlaying at least a portion of the photochrome layer 305. The protective layer 325 may be facing and in contact with the photochrome layer 305. In an embodiment, the protective layer 325 comprises a durable plastic material, and it is configured to protect the photochrome layer 305 against impacts and wear. In an embodiment, the protective layer 325 is translucent in such a way that it permits at least partial transmission of light. The protective layer 325 may be translucent for visible light, and it may be translucent for other parts of the electromagnetic radiation spectrum, such as infrared or ultraviolet light. The protective layer 325 may extend to one or more other surfaces of the user input element 300.

In an embodiment, the user input element 300 comprises a first aperture 330 which may be similar to the aperture 130 of FIG. 1a. The first aperture 330 may extend through the color layer 327. In an embodiment, the user input element 300 comprises a second aperture 335 which extends through the photochrome layer 305. In an embodiment, the second aperture 335 extends through the protective layer 325. In an embodiment, the second aperture 335 does not extend through the color layer 327 and the backing layer 320.

FIG. 3b is a diagram illustrating a cross-sectional view of a user input element 300 comprising a photochrome layer 305 and a color layer 327 on a back surface 317, according to an example embodiment of the invention. The back surface 317 is a surface generally opposite and facing away from a top surface 310. The top surface 310 is a surface which is configured to be exposed and accessible to a user and to receive a force exerted by a finger or other object. The photochrome layer 305 may be similar to the photochrome layer 105 of FIG. 1b. The user input element 300 comprises a user input element body 315 which may be similar to the user input element body 115 of FIG. 1b, and a backing layer 320 which may be similar to the backing layer 120 of FIG. 1b.

In an embodiment, the color layer 327 is a layer comprising a light color such as white. However, any suitable color is possible without departing from the spirit of the invention. In an embodiment, the color of the color layer 327 is selected in such a way that at a first illumination level the photochrome layer 305 has a shade resembling the color of the color layer 327, and at a second illumination level the photochrome layer 305 has a shade differing from the color of the color layer 327. In an embodiment, the photochrome layer 305 and the color layer are substantially not distinguishable from each other at the first illumination level. In an embodiment, the photochrome layer 305 and the color layer 327 are easily distinguishable from each other at the second illumination level.

In an embodiment, the color layer 327 is overlaying the photo chrome layer 305. The color layer 327 may be facing and in contact with the backing layer 320 and the photochrome layer 305 in such a way that the color layer 327 is located between the backing layer 320 and the photochrome layer 305. The color layer 327 may extend to one or more other surfaces of the user input element 300.

In an embodiment, the user input element 300 comprises a protective layer 325. The protective layer 325 is overlaying at least a portion of the backing layer 320. The protective layer 325 may be facing and in contact with the backing layer 320. In an embodiment, the protective layer 325 comprises a durable plastic material, and it is configured to protect the backing layer 320 against impacts and wear. In an embodiment, the protective layer 325 is translucent in such a way that it permits at least partial transmission of light. The protective layer 325 may be translucent for visible light, and it may be translucent for other parts of the electromagnetic radiation spectrum, such as infrared or ultraviolet light. The protective layer 325 may extend to one or more other surfaces of the user input element 300.

In an embodiment, the user input element 300 comprises a first aperture 330 which may be similar to the aperture 130 of FIG. 1b. The first aperture 330 may extend through the color layer 327. In an embodiment, the user input element 300 comprises a second aperture 335 which extends through the photochrome layer 305. In an embodiment, the second aperture 335 does not extend through the color layer 327 and the backing layer 320.

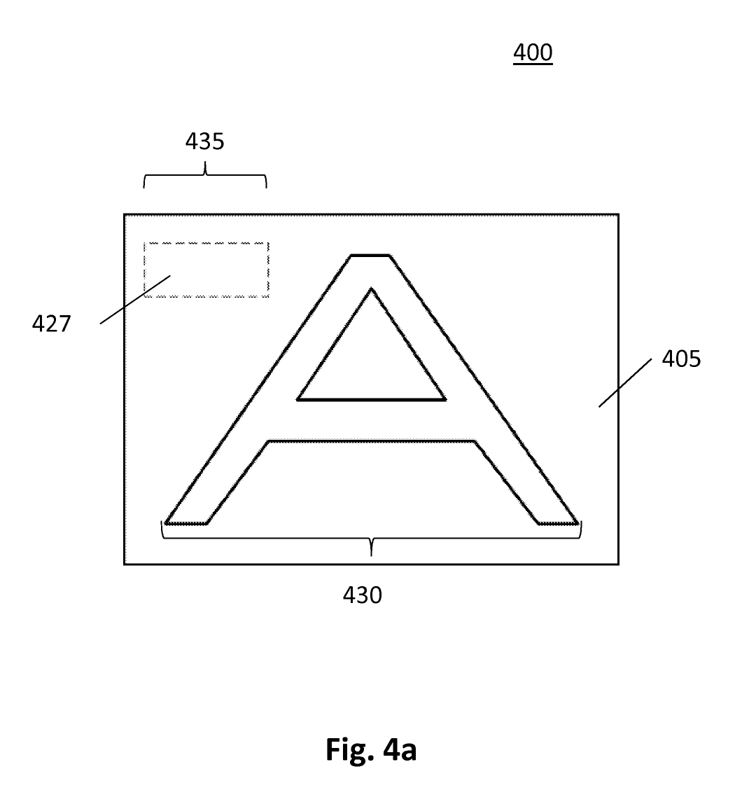

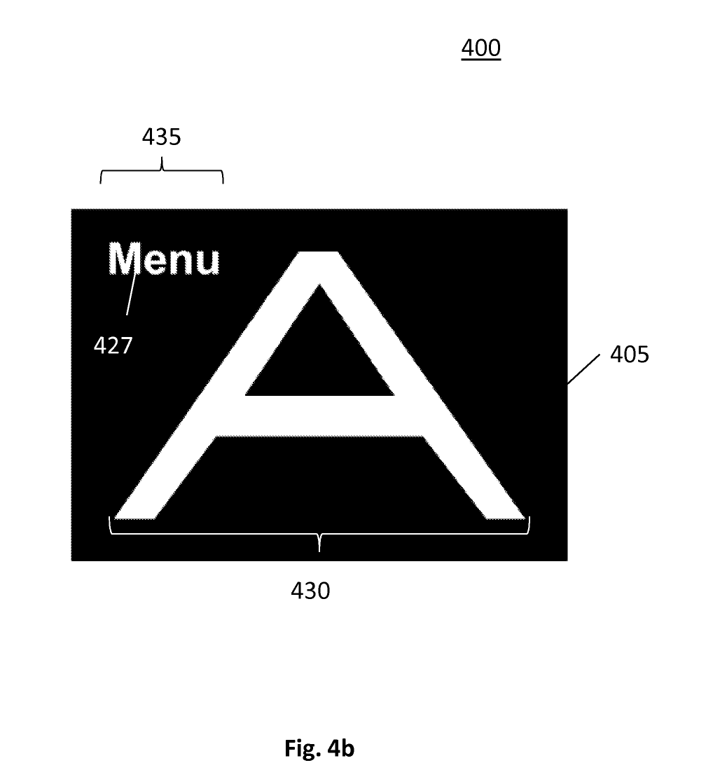

FIG. 4a is a diagram illustrating a top view of a user input element 400 comprising a photochrome layer 405 and a color layer 427, with illumination having a first illumination level, according to an example embodiment of the invention. The first illumination level may be a low illumination level. The user input element 400 may be the user input element 300 of FIG. 3a or 3b, the photochrome layer 405 may be the photochrome layer 305 of FIG. 3a or 3b, and the color layer 427 may be the color layer 327 of FIG. 3a or 3b. FIG. 4a illustrates the user input element 400 from the viewpoint of a user, from a direction approximately perpendicular to the top surface 310 of FIG. 3a or 3b. In the user input element 300 of FIG. 3a, the photochrome layer 305 may be visible through the protective layer 325 of FIG. 3a. In the user input element 300 of FIG. 3b, the photochrome layer 305 may be visible through the user input element body 315 of FIG. 3b. In an embodiment, the user input element comprises a photochrome layer 405 both on a top surface such as in FIG. 3a and on a back surface such as in FIG. 3b.

In an embodiment, the user input element 400 is configured for installation in a device comprising a backlight arrangement. In an embodiment, the backlight arrangement is configured to emit white light. However, any color or a combination of colors can be used without departing from the spirit of the invention. In an embodiment, the user input element 400 is configured to be installed in the device in such a way that at least part of the light emitted by the backlight arrangement is directed through the user input element body 315 of FIG. 3a or 3b. In an embodiment, the user input element 400 comprises a first character shaper aperture 430, which may be similar to the first aperture 330 of FIG. 3a or 3b. In an embodiment, the photochrome layer 405 is configured to form a luminance contrast with the user input element body 315 of FIG. 3a or 3b at the first illumination level at least when the backlight arrangement is emitting light. In an embodiment, the first character shaped aperture 430 appears from the user's point of view as a region of substantially higher luminance compared with the surrounding photochrome layer 405 so that the first character shaped aperture 430 is easily distinguishable when the backlight arrangement is emitting light.

In an embodiment, the user input element 400 comprises a second character shaped aperture 435, which may be the second aperture 335 of FIG. 3a or 3b. The second character shaped aperture 435 may expose a portion of the color layer 427, which may be the color layer 327 of FIG. 3a or 3b. At the first illumination level, the photochrome layer 425 may have a shade resembling the color of the color layer 427. The second character shaped aperture 435 may be, at the first illumination level, substantially not distinguishable from the surrounding photochrome layer 425. The location of the second character shaped aperture 435 is indicated with a dashed rectangle in FIG. 4a.

FIG. 4b is a diagram illustrating a top view of a user input element 400 comprising a photochrome layer 405 and a color layer 427, with illumination having a second illumination level, according to an example embodiment of the invention. The second illumination level may be a high illumination level. The user input element 400 may be the user input element 300 of FIG. 3a or 3b, the photochrome layer 405 may be the photochrome layer 305 of FIG. 3a or 3b, and the color layer 427 may be the color layer 327 of FIG. 3a or 3b. FIG. 4b illustrates the user input element 400 from the viewpoint of a user, from a direction approximately perpendicular to the top surface 310 of FIG. 3a or 3b. In the user input element 300 of FIG. 3a, the photochrome layer 305 and the color layer 327 may be visible through the protective layer 325 of FIG. 3a. In the user input element 300 of FIG. 3b, the photochrome layer 305 and the color layer 327 may be visible through the user input element body 315 of FIG. 3b. In an embodiment, the user input element comprises a photochrome layer 405 both on a top surface such as in FIG. 3a and on a back surface such as in FIG. 3b.

In an embodiment, the user input element 400 comprises a first character shaper aperture 430, which may be similar to the first aperture 330 of FIG. 3a or 3b. In an embodiment, the photochrome layer 405 is configured to form a color contrast with the user input element body 315 of FIG. 3a or 3b at the second illumination level. The photochrome layer may be configured to have, at the second illumination level, a color sufficiently different from the user input element body 315 so that the character shaped aperture 430 is easily distinguishable. In an embodiment, the first character shaped aperture 430 appears from the user's point of view as a region of substantially different color compared with the surrounding photochrome layer 405 at the second illumination level.

In an embodiment, the user input element 400 comprises a second character shaped aperture 435, which may be the second aperture 335 of FIG. 3a or 3b. In an embodiment, the second aperture exposes a portion of the color layer 427, which may be the color layer 327 of FIG. 3a or 3b. At the second illumination level, the photochrome layer 425 may have a shade different the color of the color layer 427. The second character shaped aperture 435 may be, at the second illumination level, easily distinguishable from the surrounding photochrome layer 425. In an embodiment, the second character shaped aperture 435 appears from the user's point of view as a region of substantially different color compared with the surrounding photochrome layer 405 at the second illumination level. In FIG. 4a, the second character shaped aperture 435 is illustrated as a group of letters forming the word “Menu”. However, the second character shaped aperture 435 may be any letter of any alphabet writing system, any numeral character of any numeral system, a punctuation mark, a special character, or any other symbol or shape, or a combination of symbols or shapes.

Referring to FIGS. 4a and 4b, it is possible without departing from the spirit of the invention that the second character shaped aperture 435 is easily distinguishable at the first illumination level, and substantially not distinguishable at the second illumination level. It is also possible, without departing from the spirit of the invention, to provide a user input element 400 having only a second character shaped aperture 435.

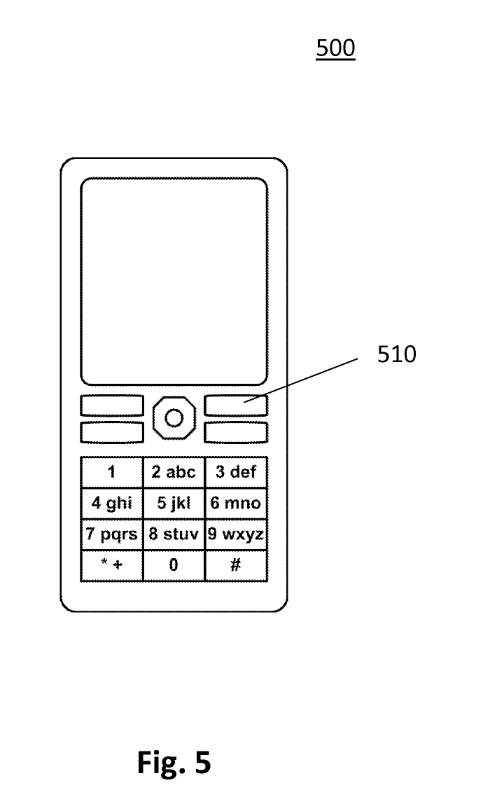

FIG. 5 is a diagram illustrating a mobile electronic device 500 comprising a user input element 510, according to an example embodiment of the invention. The user input element 510 may be a user input element 100 of FIG. 1a or 1b, or a user input element 300 of FIG. 3a or 3b. Embodiments of the invention may be comprised in some or all of the user input elements in the mobile electronic device 500. In an embodiment, the mobile electronic device 500 may be a mobile telephone. However, the mobile electronic device 500 may be a portable computer, a navigation device, a gaming device, a media player device, and electronic document reading device, or any other device.

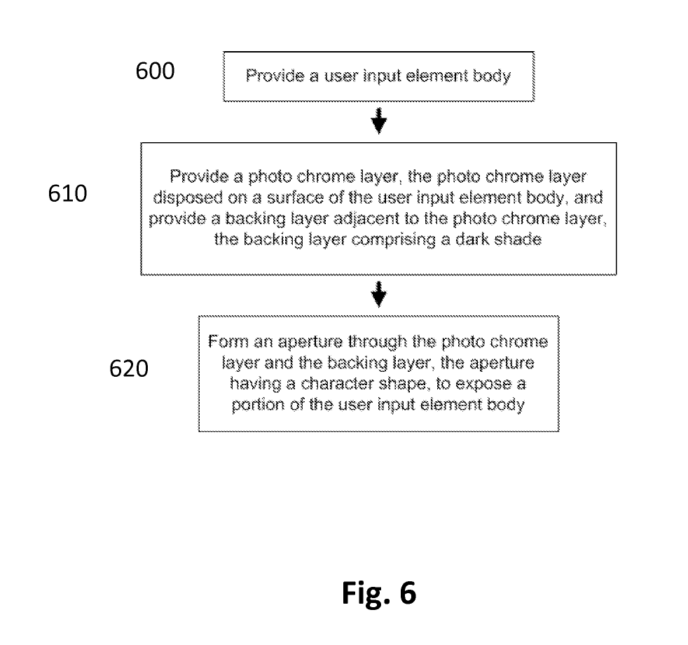

FIG. 6 is a flow diagram illustrating a method of manufacturing a user input element 200 of FIG. 2a or 2b, comprising a photochrome layer 205 of FIG. 2a or 2b, according to an example embodiment of the invention. At 600, a user input element body 115 of FIG. 1a or 1b is provided. At 610, the photochrome layer 205 and a backing layer 120 of FIG. 1a or 1b are provided. The backing layer 120 may be disposed adjacent to the photochrome layer 205. In an embodiment the backing layer 120 comprises a dark shade. The photochrome layer 205 and the backing layer 120 are disposed on a surface of the user input element 115 by printing or any other suitable method of applying a layer of material. In an embodiment, the backing layer 120 is disposed on a top surface 110 of FIG. 1a, and then the photochrome layer 205 is disposed on the backing layer 120. In an embodiment, the photochrome layer 205 is disposed on a back surface 117 of FIG. 1b, and the backing layer 120 is disposed on the photochrome layer 205.

At 620, an aperture 130 of FIG. 1a or 1b is formed through the photochrome layer 205 and the backing layer 120. The aperture 130 may be the character shaped aperture 230 of FIG. 2a or 2b. The aperture 130 may expose a portion of the user input element body 115. In an embodiment, the aperture 130 is formed by laser engraving. However, the aperture 130 may be formed by chemical etching, mask painting, chemical activation, mechanical engraving, mechanical abrasion, mechanical milling, reactive ion etching, or any other suitable method of removing material.

In an embodiment, the method comprises disposing the protective layer 125 of FIG. 1a on the top surface 110. In an embodiment, the method comprises disposing the protective layer 125 of FIG. 1b on the back surface 117 of FIG. 1b. In an embodiment, the forming of the aperture 130 is carried out after disposing the protective layer 125 in such a way that the aperture 130 extends through the protective layer 125.

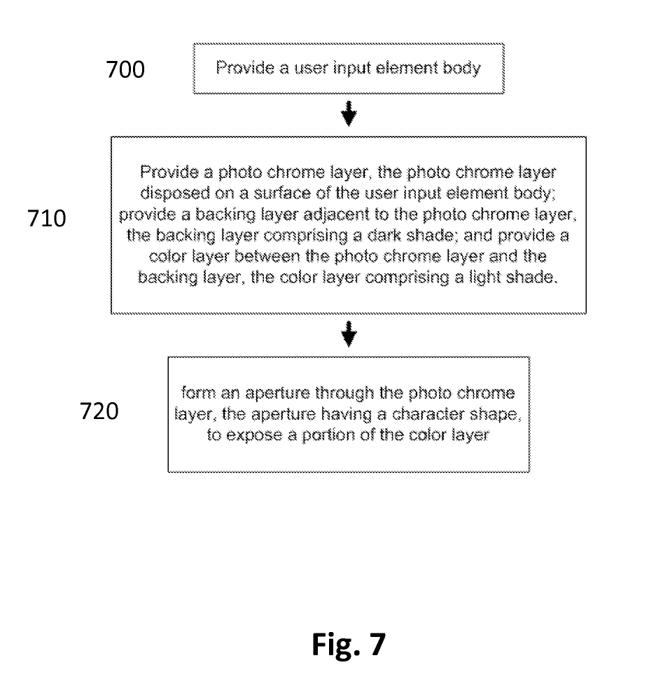

FIG. 7 is a flow diagram illustrating a method of manufacturing a user input element 400 of FIG. 4a or 4b, comprising a photochrome layer 405 of FIG. 4a or 4b, and a color layer 427 of FIG. 4a or 4b, according to an example embodiment of the invention. At 700, a user input element body 315 of FIG. 3a or 3b is provided. At 710, the photochrome layer 405 of FIG. 4a or 4b, the backing layer 320 of FIG. 3a or 3b, and the color layer 427 of FIG. 4a or 4b are provided. The backing layer 320 may be disposed adjacent to the photochrome layer 405. In an embodiment the backing layer 320 comprises a dark shade. The color layer 427 may be disposed between the photochrome layer 405 and the backing layer 320. In an embodiment, the color layer 427 comprises a light shade. The photochrome layer 405, the backing layer 320, and the color layer 427 are disposed on a surface of the user input element 315 by printing or any other suitable method of applying a layer of material. In an embodiment, the backing layer 320 is disposed on a top surface 310 of FIG. 3a, then the photochrome layer 405 is disposed on the backing layer 320, and then the color layer 427 is disposed on the photochrome layer 405 In an embodiment, the photochrome layer 405 is disposed on a back surface 317 of FIG. 3b, then the backing layer 320 is disposed on the photochrome 405, then and the color layer 427 is disposed on the photochrome layer 405.

In an embodiment, the method comprises forming the first aperture 330 of FIG. 3a or 3b through the photochrome layer 405, the color layer 427, and the backing layer 320. The first aperture 330 may be the first character shaped aperture 430 of FIG. 4a or 4b. The first aperture 330 may expose a portion of the user input element body 315. The aperture 330 may be formed by laser engraving. However, the aperture 330 may be formed chemical etching, mask painting, chemical activation, mechanical engraving, mechanical abrasion, mechanical milling, reactive ion etching, or any other suitable method of removing material.

At 720, the second aperture 335 of FIG. 3a or 3b is formed through the photochrome layer 405. The second aperture 335 may be the second character shaped aperture 435 of FIG. 4a or 4b. In an embodiment, such as in FIG. 3b, the second aperture 335 is formed through the photochrome layer 405 before the color layer 427 is disposed on the photochrome layer 405. The second aperture 335 may expose a portion of the color layer 427. The second aperture 335 may be formed by laser engraving. However, the second aperture 335 may be formed by chemical etching, chemical activation, mechanical milling, or any other suitable method of removing material.

In an embodiment, the method comprises disposing the protective layer 325 of FIG. 3a on the top surface 310. In an embodiment, the method comprises disposing the protective layer 325 of FIG. 3b on the back surface 317 of FIG. 1b. In an embodiment, such as in FIG. 3a, the forming of the second aperture 335 is carried out after disposing the protective layer 325 in such a way that the second aperture 335 extends through the protective layer 325.

Referring both to FIGS. 6 and 7, it is possible to combine methods according to embodiments of the invention in various ways. By way of example, it is possible to combine printing on the top surface 110 or 310 with printing on the back surface 117 or 317, and it is possible to form either the first aperture 330 or the second aperture 335, or both.

Without in any way limiting the scope, interpretation, or application of the claims appearing below, a technical effect of one or more of the example embodiments disclosed herein is that a user input element is provided, the user input element having one or more symbols or shapes on a top or back surface. Another technical effect of one or more of the example embodiments disclosed herein is that the symbols or shapes are easily distinguishable under a broad range of illumination levels. Another technical effect of one or more of the example embodiments disclosed herein is that a user input element is provided, the user input element having one or more symbols or shapes is provided, the symbols or shapes being substantially not distinguishable at a first illumination level, and distinguishable at a second illumination level. Another technical effect of one or more of the example embodiments disclosed herein is that a cheap and durable user input element suitable for mass manufacturing is provided.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a user input element body;
a photochrome layer, the photochrome layer disposed on a surface of the user input element body; and
an aperture through the photochrome layer, the aperture having a character shape.

2. An apparatus as in claim 1, wherein a backing layer is disposed adjacent to the photochrome layer, the backing layer comprising a dark shade.

3. An apparatus as in claim 2, wherein a color layer is disposed between the photochrome layer and the backing layer, the color layer comprising a light shade.

4. An apparatus as in claim 2, wherein the photochrome layer and the backing layer are disposed on a top surface of the user input element.

5. An apparatus as in claim 4, wherein a translucent protective layer is disposed on the photochrome layer.

6. An apparatus as in claim 2, wherein the photochrome layer and the backing layer are disposed on a back surface of the user input element body.

7. An apparatus as in claim 6, wherein a translucent protective layer is disposed on the backing layer.

8. An apparatus as in claim 2, wherein the aperture extends through the backing layer to expose a portion of the user input element body.

9. An apparatus as in claim 8, wherein the photochrome layer is configured to form a luminance contrast with the user input element body at a first illumination level when the user input element body is illuminated.

10. An apparatus as in claim 8, wherein the photochrome layer is configured to form a color contrast with the user input element body at a second illumination level, the second illumination level being higher than the first illumination level.

11. An apparatus as in claim 3, wherein the aperture extends through the photochrome layer to expose a portion of the color layer.

12. An apparatus as in claim 11, wherein the photochrome layer is configured to have a shade resembling the color layer at a first illumination level.

13. An apparatus as in claim 11, wherein the photochrome layer is configured to form a color contrast with the color layer at a second illumination level, the second illumination level being higher than the first illumination level.

14. An apparatus as in claim 1, wherein the user input element comprises a translucent material.

15. An apparatus as in claim 1, comprised in a mobile electronic device.

16. A method, comprising:
providing a user input element body;
providing a photochrome layer, the photochrome layer disposed on a surface of the user input element body; and
forming an aperture through the photochrome layer, the aperture having a character shape.

17. A method as in claim 16, wherein a backing layer is provided adjacent to the photochrome layer, the backing layer comprising a dark shade.

18. A method as in claim 17, wherein a color layer is provided between the photochrome layer and the backing layer, the color layer comprising a light shade.

19. A method as in claim 18, wherein the aperture is formed to extend through the photochrome layer to expose a portion of the color layer.

20. A method as in claim 17, wherein the aperture is formed to extend through the backing layer to expose a portion of the user input element body.
